(19) United States
(12) Patent Application Publication
(10) Pub. No.: US 2003/0118102 A1
(43) Pub. Date: Jun. 26, 2003

(54) Encoding and decoding of truncated scalable bitstreams

(76) Inventors: Weiping Li, Palo Alto, CA (US); Fan Ling, Santa Clara, CA (US)

Correspondence Address: Martin Novack, Attorney for Applicant, 17414 Via Capri East, Boca Raton, FL, 33496, US

(21) Appl. No.: 10/047,910

(22) Filed: Nov. 9, 2001

Related U.S. Application Data
(60) Provisional application No. 60/247,334, filed on Nov. 10, 2000.

(51) Int. Cl. H04N 7/12

(52) U.S. Cl. 375/240.12; 375/240.25; 375/240.26

(57) ABSTRACT

The disclosure has application, for use in conjunction with a video encoding/decoding technique wherein images are encoded into frame-representative bitstreams that include start codes and variable length codes and at least some of the bitstreams are truncated for streaming, ultimately, to a decoder for decoding. A disclosed method includes the following steps: selecting an end code having a value that is different than any start code and any variable length code of the bitstream; and appending the end code to the bitstreams.

### RELATED APPLICATION

This application claims priority from U.S. Provisional Patent Application No. 60/247,334, filed Nov. 10, 2000, and said Provisional Patent Application is incorporated herein by reference.

### FIELD OF THE INVENTION

This invention relates to encoding and decoding of video signals, and, more particularly, to a method and apparatus for encoding and decoding of truncated scalable bitstreams used for streaming encoded video signals.

### BACKGROUND OF THE INVENTION

In a video coding technique with fine granularity scalability (FGS), such as the one in MPEG-4, a bitstream of each frame can be truncated into any number of bits and can still be decodable to reconstruct the frame. The video quality of the frame is proportional to the number of bits received and decoded by the decoder. Decoding of a truncated scalable bitstream requires special consideration compared with decoding of a regular complete non-scalable or layered scalable bitstream. For a regular complete bitstream, the bitstream syntax defines what to expect in the input bits. The decoder knows where the bitstream ends for each frame according to the syntax definition. However, a truncated scalable bitstream contains an incomplete bitstream for each frame. The decoder does not know if a frame ends by just decoding the bitstream according to the syntax. It has to rely on the start code of the next frame to know that the current frame is ended.

Each frame starts with a frame start code that is not emulated in the bitstream by design. In MPEG-4, all start codes have 32 bits starting with 23 zeros and a one. The last 8 bits are used to distinguish different start codes. In MPEG-4, decoding of the truncated bitstream is not normative. One suggested method for decoding a truncated bitstream is to look ahead 32 bits at every byte-aligned position in the bitstream indicated by a pointer. If the 32 bits form the frame start code, the decoder either completes decoding up to the frame start code or discards the few bits before the frame start code. Otherwise, the first 8 bits of the 32 bits are information bits to be decoded for the frame. The decoder moves forward the pointer by one byte and looks ahead another 32 bits to check for the frame start code. This method requires the decoder to look ahead into the bitstream, every time reading one byte out of the bitstream. This is not efficient because extra operations are needed for file or buffer access for the look ahead in addition to reading bits out of the file or buffer.

It is among the objects of the present invention to devise a more efficient method that will enable decoding of a truncated bitstream without looking ahead.

### SUMMARY OF THE INVENTION

The present invention has application, inter allia, for use in conjunction with a video encoding/decoding technique wherein images are encoded into frame-representative bitstreams that include start codes and variable length codes and at least some of the bitstreams are truncated for streaming, ultimately, to a decoder for decoding. An embodiment of the method of the invention includes the following steps: selecting an end code having a value that is different than any start code and any variable length code of the bitstream; and appending the end code to the bitstreams.

In a preferred embodiment of the invention, the decoding of the bitstream includes interpreting the code, or a portion thereof, as an invalid symbol that cannot be decoded. In this embodiment, the decoding of the bitstream includes initiating a process of looking for the next start code after an invalid symbol has occured. Also, in a form of this embodiment, the start code is a string of zeros followed by a one, and the end code is another string of zeros longer than the string of zeros of the start code.

Further features and advantages of the invention will become more readily apparent from the following detailed description when taken in conjunction with the accompanying drawings.

### BRIEF DESCRIPTION OF THE DRAWINGS

FIG. 1 is a diagram illustrating decoding of a regular bitstream.

FIG. 2 is a diagram illustrating decoding of a truncated bitstream using looking ahead.

FIG. 3 is a diagram illustrating decoding a truncated bitstream without looking ahead.

FIG. 4 is a block diagram of an apparatus which can be used in practicing embodiments of the invention.

FIG. 5 is a flow diagram of a routine for programming the encoder processor in accordance with an embodiment of the invention.

FIG. 6 is a flow diagram of a routine for programming the decoder processor in accordance with an embodiment of the invention.

### DETAILED DESCRIPTION

FIG. 1 shows the decoding process of a regular complete bitstream. The decoder is able to decode the bitstream without looking ahead by following the syntax. FIG. 2 describes the looking ahead method for decoding a truncated bitstream. The bitstream file or buffer has to be accessed twice for looking for the frame start code and reading bits out for decoding.

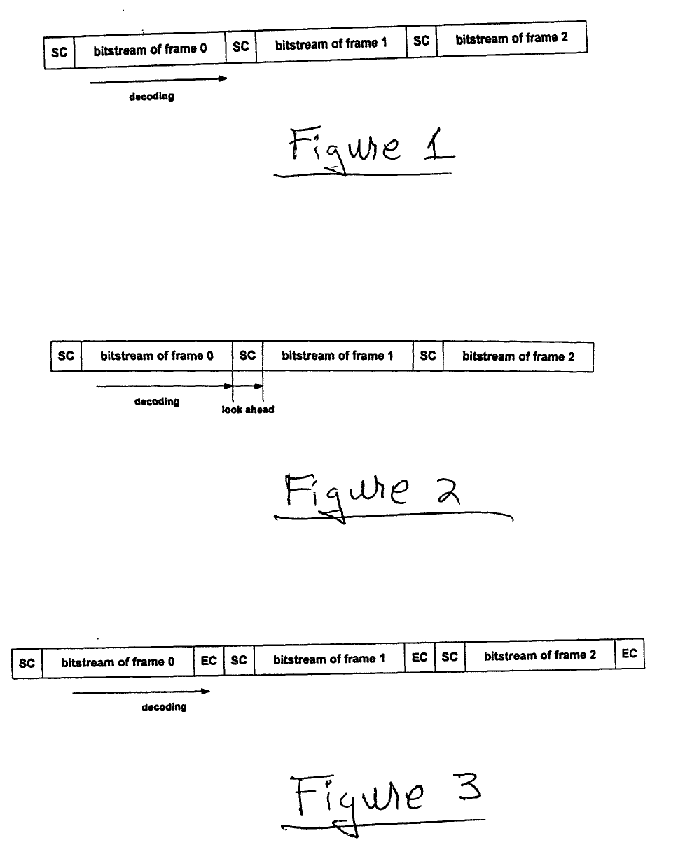

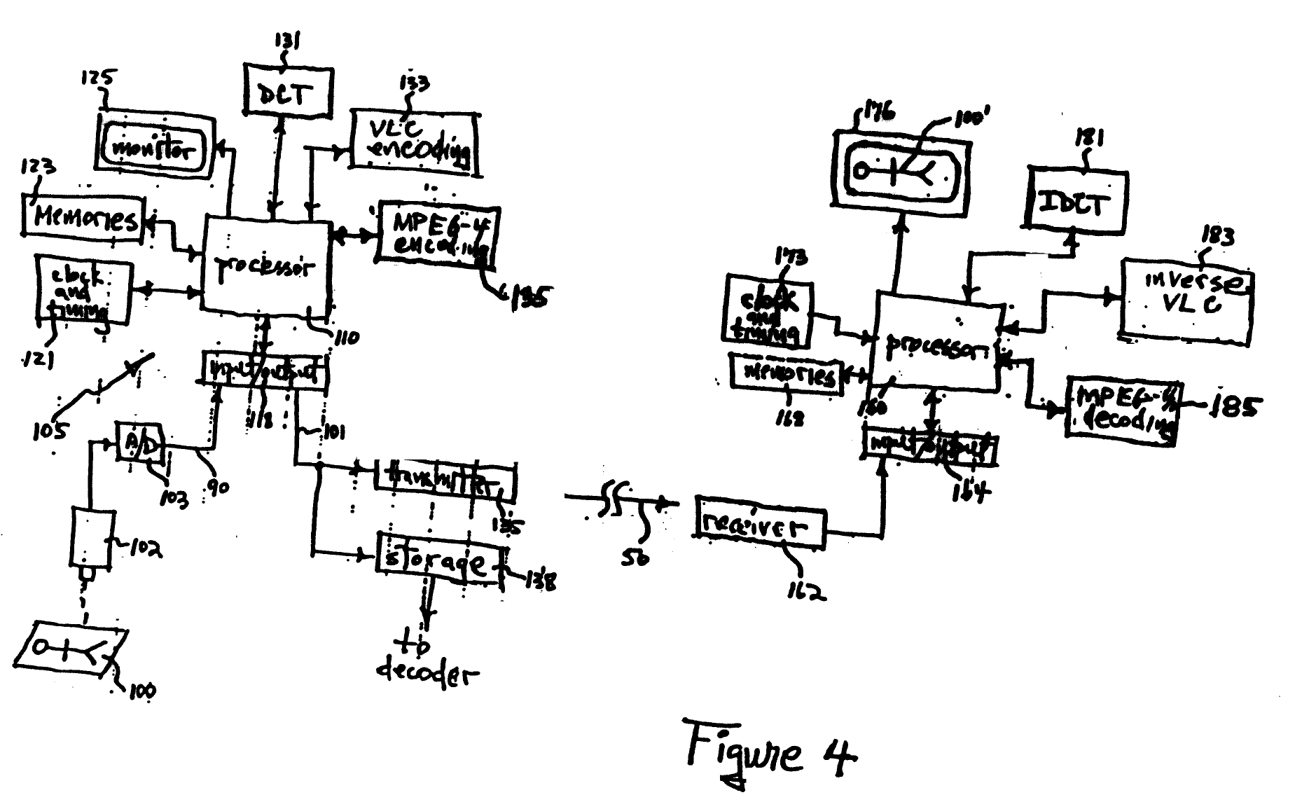

FIG. 3 illustrates operation consistent with an embodiment hereof that uses a frame end code to indicate a frame is ended. The frame end code is not put into the bitstream at the time of encoding, but at the time of truncating the bitstream for transmission. There is no need for looking ahead to search for the end code because the end code is chosen in such a way that it does not allow the decoder to reach the next frame start code with the decoding process. One choice for the frame end code is hereof is to use 32 bits of zeros. Since there is no start code emulation in the bitstream, the maximum number of consecutive zeros can only be 22. The decoder may take the first few zero bits in the frame end code as a part of a valid variable length code. However, it cannot pass the entire frame end code in a normal decoding process. Therefore, an error signal is set when the decoder gets into the frame end code. Then the decoder looks for the next frame start code to start decoding the next frame.

A feature hereof is that the frame end code does not have to be standardized as long as the value of the frame end code is not one of the start codes and does not form any valid variable length code. The decoders that use the looking ahead method are able to decode the bitstreams with the frame end code. They can simply ignore the frame end code after finding the next frame start code.

Referring to FIG. 3, there is shown a block diagram of an apparatus, at least parts of which can be used in practicing embodiments of the invention. A video camera 102, or other source of video signal, produces an array of pixel-representative signals that are coupled to an analog-to-digital converter 103, which is, in turn, coupled to the processor 110 of an encoder 105. When programmed in the manner to be described, the processor 110 and its associated circuits can be used to implement embodiments of the invention. The processor 110 may be any suitable processor, for example an electronic digital processor or microprocessor. It will be understood that any general purpose or special purpose processor, or other machine or circuitry that can perform the functions described herein, electronically, optically, or by other means, can be utilized. The processor 110, which for purposes of the particular described embodiments hereof can be considered as the processor or CPU of a general purpose electronic digital computer, will typically include memories 123, clock and timing circuitry 121, input/output functions 118 and monitor 125, which may all be of conventional types. In the present embodiment blocks 131, 133, and 135 represent functions that can be implemented in hardware, software, or a combination thereof for implementing coding of the type employed for MPEG-4 video encoding. The block 131 represents a discrete cosine transform function that can be implemented, for example, using commercially available DCT chips or combinations of such chips with known software, the block 133 represents a variable length coding (VLC) encoding function, and the block 135 represents other known MPEG-4 encoding modules, it being understood that onlyl those known functions needed in describing and implementing the invention are treated in describing and implementing the invention are treated herein in any detail.

With the processor appropriately programmed, as described hereinbelow, an encoded output signal 101 is produced which can be a compressed version of the input signal 90 and requires less bandwidth and/or less memory for storage. In the illustration of FIG. 1, the encoded signal 101 is shown as being coupled to a transmitter 135 for transmission over a communications medium (e.g. air, cable, network, fiber optical link, microwave link, etc.) 50 to a receiver 162. The encoded signal is also illustrated as being coupled to a storage medium 138, which may alternatively be associated with or part of the processor subsystem 110, and which has an output that can be decoded using the decoder to be described.

Coupled with the receiver 162 is a decoder 155 that includes a similar processor 160 (which will preferably be a microprocessor in decoder equipment) and associated peripherals and circuits of similar type to those described in the encoder. These include input/output circuitry 164, memories 168, clock and timing circuitry 173, and a monitor 176 that can display decoded video 100′. Also provided are blocks 181, 183, and 185 that represent functions which (like their counterparts 131, 133, and 135 in the encoder) can be implemented in hardware, software, or a combination thereof. The block 181 represents an inverse discrete cosine transform function, the block 183 represents an inverse variable length coding function, and the block 185 represents other MPEG-4 decoding functions.

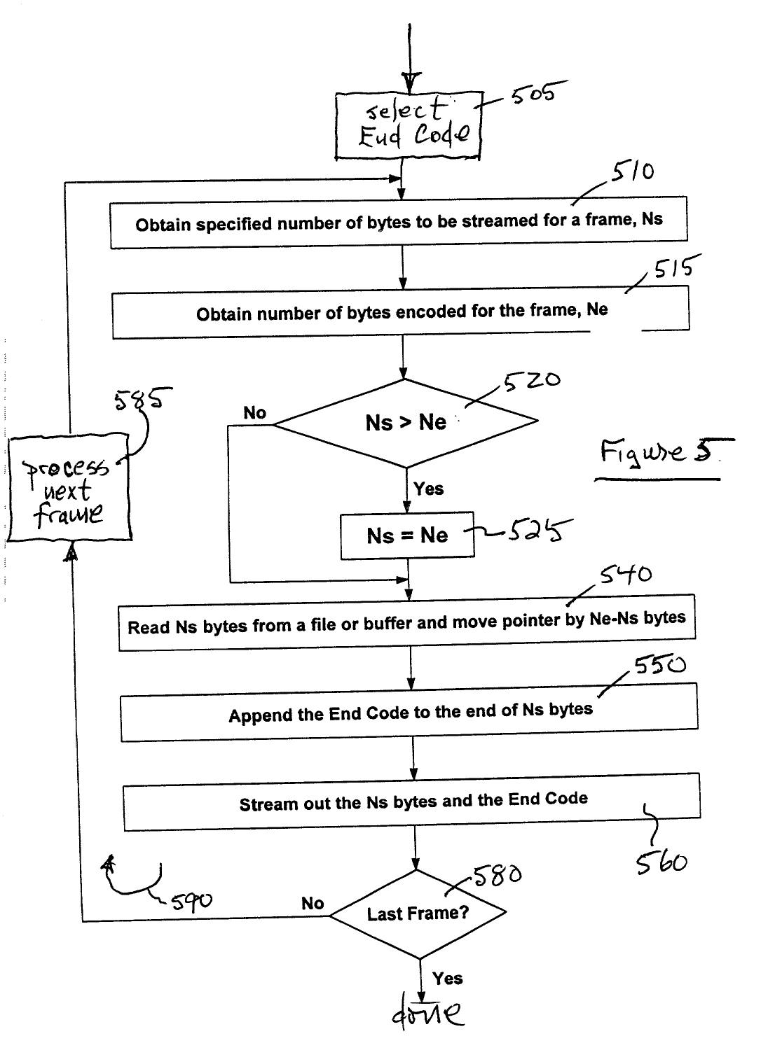

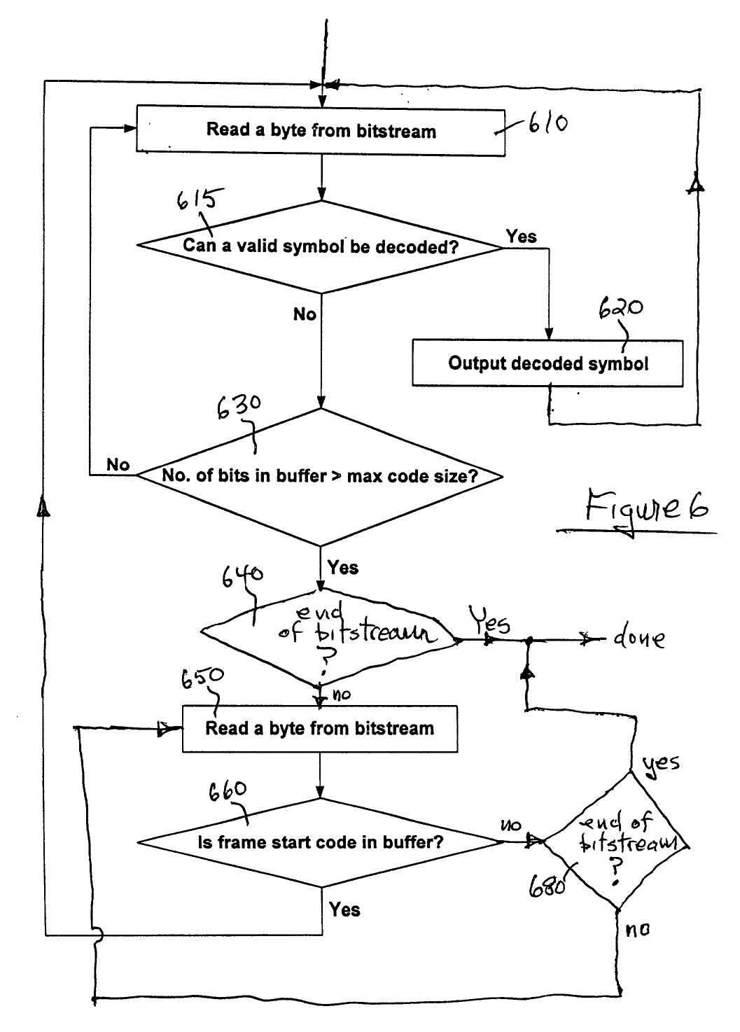

Referring to FIG. 5, there is shown a flow diagram of a routine for programming the encoder processor in accordance with an embodiment of the invention. The block 505 represents selection of an end code, in accordance with the principles hereof. The block 510 represents reading of the specified number of bytes to be streamed for a frame, designate Ns. The block 515 represents reading of the number of bytes to be encoded for the frame, designated Ne. Determination is made (decision block 520) as to whether Ns is greater than Ne. If so, Ns is set equal to Ne (since the number of bytes to be streamed for a frame cannot be greater than the number of encoded bits available), as represented by block 525, and block 540 is entered. If Ns is not greater than Ne, block 540 is entered directly. The block 540 represents reading Ns bytes from a file (or buffer) and moving a pointer by Ne-Ns bytes. Then, the end code is appended to the end of Ns bytes (block 550), and the Ns bytes and the end code are streamed out (block 560). Determination is made (decision block 580) as to whether the last frame to be processed has been reached. If not, the next frame to be processed is input (block 585), the block 510 is re-entered, and the loop 590 is continued until all frames have been processed.

Referring to FIG. 6, there is shown a flow diagram of a routine for programming the decoder processor in accordance with an embodiment of the invention. The block 610 represent reading of a byte from the bitstream. Determination is then made (decision block 615) as to whether a valid symbol can be decoded by the decoder. If so, the decoded symbol is output (block 620), and bock 610 is re-entered. If not, determination is made (decision block 630) as to whether the number of bits in the buffer is greater than the maximum code size. If not, the bock 610 is re-entered, and the described loops are continued until the number of bits in the buffer is greater than the maximum code size. The decision block 540 is then entered, and determination is made as to whether the end of the bitstream has been reached. If so, the processing of this bitstream is complete. If not, a byte is read from the bitstream (block 650), and determination is made (decision block 660) as to whether the frame start code is in the buffer. If so, the block 610 is re-entered and another byte is read from the bitstream. If not, determination is made (decision block 680) as to whether the end of the bitstream has been reached. If not, block 650 is re-entered, and the process is continued until the end of the bitstream has been reached.

1. For use in conjunction with a video encoding/decoding technique wherein images are encoded into frame-representative bitstreams that include start codes and variable length codes and at least some of said bitstreams are truncated for streaming, ultimately, to a decoder for decoding; a method comprising the steps of:
selecting an end code having a value that is different than any start code and any variable length code of said bitstreams; and
appending said end code to said bitstreams.

2. The method as defined by claim 1, further comprising decoding the streamed encoded bit streams.

3. The method as defined by claim 2, wherein said decoding of the bitstream includes interpreting said end code, or a portion thereof, as an invalid symbol that cannot be decoded.

4. The method as defined by claim 3, wherein said decoding of the bitstream includes initiating a process of looking for the next start code after an invalid symbol has occured.

5. The method as defined by claim 1, wherein said end code is a string of zeros.

6. The method as defined by claim 2, wherein said end code is a string of zeros.

7. The method as defined by claim 3, wherein said end code is a string of zeros.

8. The method as defined by claim 4, wherein said end code is a string of zeros.

9. The method as defined by claim 1, wherein said start code is a string of zeros followed by a one, and said end code is another string of zeros longer than the string of zeros of said start code.

10. The method as defined by claim 2, wherein said start code is a string of zeros followed by a one, and said end code is another string of zeros longer than the string of zeros of said start code.

11. The method as defined by claim 3, wherein said start code is a string of zeros followed by a one, and said end code is another string of zeros longer than the string of zeros of said start code.

12. The method as defined by claim 4, wherein said start code is a string of zeros followed by a one, and said end code is another string of zeros longer than the string of zeros of said start code.

13. The method as defined by claim 2, wherein said decoding is performed without looking for a specific end code symbol.

14. The method as defined by claim 3, wherein said decoding is performed without looking for a specific end code symbol.

15. The method as defined by claim 12, wherein said decoding is performed without looking for a specific end code symbol.

16. The method as defined by claim 1, wherein said truncated bitstreams are MPEG-4 fine granularity scaling codes.

17. The method as defined by claim 3, wherein said truncated bitstreams are MPEG-4 fine granularity scaling codes.

18. The method as defined by claim 12, wherein said truncated bitstreams are MPEG-4 fine granularity scaling codes.

19. For use in conjunction with a video encoding/decoding technique wherein images are encoded into frame-representative bitstreams that include start codes and variable length codes and at least some of said bitstreams are truncated for streaming, ultimately, to a decoder for decoding; and apparatus comprising:
means for selecting an end code having a value that is different than any start code and any variable length code of said bitstreams; and
means for appending said end code to said bitstreams.

20. Apparatus as defined by claim 1, further comprising means for decoding the streamed encoded bit streams.
